(19) United States
(12) Patent Application Publication
(10) Pub. No.: US 2023/0273052 A1
(43) Pub. Date: Aug. 31, 2023

(54) Method for Determining Information About a Change of a Mobile Gardening, Forestry, Construction or Soil-Working Device, Mobile Gardening, Forestry, Construction or Soil-Working Device and System

(71) Applicant: Andreas Stihl AG & Co. KG, Waiblingen (DE)

(72) Inventors: Johannes LANG, Korb (DE); Johann-Sebastian RENZ, Gomaringen (DE); Philipp Tobias Martin HUEGEL, Korb (DE)

(21) Appl. No.: 18/113,977

(22) Filed: Feb. 24, 2023

(30) Foreign Application Priority Data
Feb. 25, 2022 (EP) 22158917.9

(51) Int. Cl. G01D 21/02; B25F 5/00

(52) U.S. Cl. CPC G01D 21/02; B25F 5/00

(57) ABSTRACT

A method determines information about a change of a mobile gardening, forestry, construction or soil-working device, wherein the gardening, forestry, construction or soil-working device has a motor drive system. The method includes: a) repeated detection of a characteristic variable of the motor drive system in respect of time, b) comparison of at least one first value of the detected characteristic variable or a variable based on it from a first time period and at least one second value of the detected characteristic variable or the variable based on it from a second time period with one another, and c) storage of the information about the change of the gardening, forestry, construction or soil-working device depending on a result of the comparison.

### CROSS REFERENCE TO RELATED APPLICATION

This application claims priority under 35 U.S.C. § 119 from European Patent Application No. 22158917.9, filed Feb. 25, 2022, the entire disclosure of which is herein expressly incorporated by reference.

### BACKGROUND AND SUMMARY

The invention relates to a method for determination of information about a change of a mobile gardening, forestry, construction or soil-working device, to a mobile gardening, forestry, construction or soil-working device for determination of information about a change of the gardening, forestry, construction or soil-working device, and to a system having such a gardening, forestry, construction or soil-working device.

The invention is based on the problem of providing a method for determination of information about a change of a mobile gardening, forestry, construction or soil-working device, a mobile gardening, forestry, construction or soil-working device for determination of information about a change of the gardening, forestry, construction or soil-working device, and a system having such a gardening, forestry, construction or soil-working device, wherein the method, the gardening, forestry, construction or soil-working device and the system each have improved properties.

The invention solves this problem by providing a method and a mobile gardening, forestry, construction or soil-working device described in the independent claims. Advantageous developments and/or refinements of the invention are described in the dependent claims.

The method according to the invention is intended or designed for determination of information about a change of a mobile gardening, forestry, construction or soil-working device. The gardening, forestry, construction or soil-working device has a motor drive system. The method comprises the steps of: a) repeated detection of a characteristic variable of the motor drive system in respect of time, b) comparison of at least, in particular only, one first value of the detected characteristic variable or a variable based on it from a first time period and at least, in particular only, one second value of the detected characteristic variable, in particular of the same type, or the variable based on it, in particular of the same type, from a second time period with one another, and c) storage of the information about the change of the gardening, forestry, construction or soil-working device depending on a result of the comparison.

This, in particular the comparison, renders possible identification of the change. Additionally or alternatively, this, in particular the storage depending on the result of the comparison, renders possible the storage, in particular only, in the case of the change, and in particular not in the other case, in particular no change. Therefore, this renders possible reduced-information and capability-saving storage, in particular advantageously for the mobile gardening, forestry, construction or soil-working device, in which capabilities may be limited.

In particular, the method, the determination, the detection and/or the storage can be automatic.

The terms “log”, “register” or “trigger” can be used synonymously with the term “determine”.

Determining the information can involve determining a content of the information.

The information can be qualitative and/or quantitative.

The term “event” can be used synonymously with the term “change”.

The change can be an impairment or an improvement and/or can be brief, in particular between the first time period and the second time period in respect of time.

The change can be a change in a component and/or an application of the gardening, forestry, construction or soil-working device, in particular the motor drive system.

The term “portable” can be used synonymously with the term “mobile”. Additionally or alternatively, mobile gardening, forestry, construction or soil-working device can mean that the gardening, forestry, construction or soil-working device can have a mass of at most 50 kg (kilograms), in particular of at most 20 kg, in particular of at most 10 kg, in particular of at most 5 kg, and/or of at least 0.5 kg, in particular of at least 1 kg, in particular of at least 2 kg.

The gardening, forestry, construction or soil-working device can have a machining tool. Additionally or alternatively, the motor drive system can be designed for, in particular automatic, driving of the gardening, forestry, construction or soil-working device, in particular the machining tool.

The motor drive system can have a drive unit, in particular a drive motor, an, in particular, electric motor controller, in particular with an evaluation device or unit, and/or an, in particular electrical, detection device, in particular at least one sensor. In particular, step a) and/or the detection by means of the detection device can be executed by means of the detection device. Additionally or alternatively, step b) and/or the comparison can be executed by means of the evaluation device. Further additionally or alternatively, the, in particular detected, characteristic variable to form the variable based on it and/or the information can be evaluated, in particular by means of the evaluation device.

The term “configured” can be used synonymously with the term “designed”.

The term “comprises” or “possesses” can be used synonymously with the term “has”.

Repeated in respect of time can mean repeated severally in respect of time, permanently in respect of time or continuously in respect of time, in particular regularly or periodically, for example with a repetition frequency or a sampling rate of at most 1000 Hz (Hertz), in particular of at most 100 Hz, in particular of at most 10 Hz, in particular of at most 1 Hz, and/or of at least 1*10⁻⁴ Hz, in particular of at least 2.8*10⁻⁴ Hz.

The detection can be performed not only with a fixed repetition frequency but also in a manner triggered by motor rotation, for example at up to 15,000 revolutions per minute with a repetition frequency of 250 Hz. Additionally or alternatively, the detection of the characteristic variable, in particular repeated in respect of time, can be detection of one value, in particular of values, of the characteristic variable, in particular repeated in respect of time.

The characteristic variable and/or the variable based on it can be physical.

The variable based on another variable can be based on the characteristic variable. Additionally or alternatively, the variable based on another variable can be a variation over time or a time gradient or a time derivative, in particular rendered possible by the repeated detection in respect of time.

The term “kind” can be used synonymously with the term “type”.

The, in particular respective, time period can be a detection time period.

The term “time interval” can be used synonymously with the term “time period”.

The second time period can be different from the first time period.

The storage can be storage of the contents of the information.

The storage can be executed, in particular only, in the case of the, in particular sufficient, change and in particular not in the other case, in particular no, in particular sufficient, change.

Step b) can be executed after step a) in respect of time. Additionally or alternatively, step c) can be executed after step b) in respect of time. Further additionally or alternatively, step b) and/or step c) can be executed repeatedly in respect of time. Further additionally or alternatively, step a) and/or step b) can be executed, in particular repeatedly, after step c) in respect of time. Further additionally or alternatively, the method can be executed repeatedly in respect of time.

In one development of the invention, the gardening, forestry, construction or soil-working device, in particular the motor drive system, has a variable memory device and/or an event memory device. Step a) comprises: storage, in particular storage repeated in respect of time and/or automatic storage, of the detected characteristic variable or a, in particular the, variable based on it in the variable memory device. Step b) comprises: comparison of at least, in particular only, the first value of the stored characteristic variable or the stored variable or a, in particular the, variable based on it and at least, in particular only, the second value of the stored characteristic variable, in particular of the same type, or the stored variable, in particular of the same type, or the variable based on it, in particular of the same type, with one another. Additionally or alternatively, step c) comprises: storage of the information in the event memory device. This, in particular the variable memory device, renders possible the comparison, in particular at a subsequent point in time. Additionally or alternatively, this, in particular the event memory device, renders possible the storage of the information. In particular, the variable memory device and/or the event memory device can be electrical and/or digital. Additionally or alternatively, the event memory device can be different from the variable memory device. In particular, the variable memory device and the event memory device can be different memory areas of the same memory device. Further additionally or alternatively, the variable based on the characteristic variable can be based on an intermediate variable based on the characteristic variable, wherein the intermediate variable can be stored. Further additionally or alternatively, the storage can be the storage of a value, in particular of values, of the characteristic variable, the intermediate variable and/or the variable based on them. Further additionally or alternatively, the first value and/or the second value can be or may have been stored in the variable memory device.

In one refinement of the invention, the variable memory device is a non-volatile variable memory device. Additionally or alternatively, the event memory device is a non-volatile event memory device and/or has a ring memory, in particular is the ring memory. This renders possible, in particular the non-volatile variable memory device and/or the non-volatile event memory device render/renders possible, energy-saving storage in respect of time. Additionally or alternatively, this, in particular the ring memory, renders possible a minimal memory. In particular, the variable memory device and/or the event memory device can be an EEPROM memory. Additionally or alternatively, the non-volatile variable memory device and/or the non-volatile event memory device, in particular jointly, can have, in particular be, in particular only, 1 to 8 kB (kilobytes). Further additionally or alternatively, the event memory device can have, in particular be, a FiFo (First In-First Out) memory device. In particular, the term “ring memory” can be used synonymously with the term “FiFO memory device”.

In one development of the invention, the second time period is longer than the first time period. In particular, the second time period is a total run time period apart from the, in particular current, first time period. Additionally or alternatively, the second time period at least partially, in particular completely, precedes the, in particular current, first time period. This renders possible the identification of the, in particular brief, change. In particular, the first time period can be, in particular only, 0.5 to 2 h (hours), in particular 1 h, long. Additionally or alternatively, at least, in particular only, one value, in particular one mean value and/or one accumulated value, of the total run time period can or may have been stored in the variable memory device.

In one development of the invention, the second time period has, in particular only, first time periods, in particular preceding the, in particular current, first time period. In particular, the second time period is the first time periods. Additionally or alternatively, the second value is a mean value and/or an accumulated value, in particular only, of values of the detected characteristic variable or the variable based on it, in particular only, from first time periods, in particular preceding the, in particular current, first time period. This renders possible reduced-information or capability-saving storage, in particular in the variable memory device. In particular, the first value can be a mean value and/or an accumulated value, in particular only, of values of the detected characteristic variable or the variable based on it, in particular only, from the, in particular current, first time period. Additionally or alternatively, the mean value can be an arithmetic mean value or average value.

In particular, step b) can comprise: forming, in particular repeatedly and/or automatically forming in respect of time, a deviation, in particular a value of the deviation, between at least, in particular only, the first value and at least, in particular only, the second value. Step c) comprises: storage depending on whether or that the deviation is equal to or greater than a deviation limit value, or in particular is not. That is to say, in the event of a small or zero deviation, the storage cannot or need not be executed. This renders possible identification of the change. In particular, the deviation limit value can be specified, in particular specifically in respect of type, in particular for a type of the characteristic variable or the variables based on it. Additionally or alternatively, the term “difference” can be used synonymously with the term “deviation”.

In one development of the invention, step b) comprises: forming, in particular repeatedly and/or automatically forming in respect of time, a ratio, in particular a value for the ratio, at least, in particular only, of the first value and at least, in particular only, the second value in relation to one another. Step c) comprises: storage depending on whether or that the ratio is, in particular either, equal to or greater than a ratio maximum limit value or equal to or less than a ratio minimum limit value, or in particular not, in particular wherein the ratio minimum limit value is less than the ratio maximum limit value. That is to say, given a ratio of less than the ratio maximum limit value and/or greater than the ratio minimum limit value, the storage cannot or need not be executed. This renders possible the identification of the change. In particular, the ratio maximum limit value and/or the ratio minimum limit value can be specified, in particular specifically, in particular type-specifically, for a type of the characteristic variable or the variables based on it. Additionally or alternatively, the ratio maximum limit value can be 120% (per cent). Further additionally or alternatively, the ratio minimum limit value can be 80%. Further additionally or alternatively, the term “calculate” can be used synonymously with the term “form”.

In one development of the invention, step b) comprises: repeated, and in particular automatic, comparison of at least, in particular only, one, in particular current, first value for the detected characteristic variable or the variable based on it from an, in particular current, first time period and at least one, in particular current, second value for the detected characteristic variable, in particular of the same type, or the variable based on it, in particular of the same type, from an, in particular current, second time period with one another in respect of time. Step c) comprises: storage of, in particular automatic storage of, the information about the change of the gardening, forestry, construction or soil-working device depending on a result, in particular of the same type, of the repeated comparison in respect of time and whether or that information, in particular of the same type, about a change, in particular of the same type, of the gardening, forestry, construction or soil-working device had not been stored, in particular directly, beforehand or in the event of at least one, in particular directly, preceding execution, in particular of step c), depending on at least the result, in particular of the same type, at least of the, in particular directly, preceding comparison. That is to say, in particular only, one-off storage of the information about the change of the gardening, forestry, construction or soil-working device depending on the, in particular unchanged or the same, result. This renders it possible for, in particular direct, subsequent storage of the same information to be avoided. Therefore, this renders possible particularly reduced-information or capability-saving storage, in particular in the event memory device. In particular, step c) can comprise: storage of the information about the change of the gardening, forestry, construction or soil-working device depending on a result of the repeated comparison in respect of time and whether or that different information, in particular of a different type, about a different change, in particular of a different type, of the gardening, forestry, construction or soil-working device had not been stored, in particular directly, beforehand or in the event of at least one, in particular directly, preceding execution, in particular of step c), depending on at least a different result, in particular of a different type, at least of the, in particular directly, preceding comparison. Additionally or alternatively, the term “immediately” can be used synonymously with the term “directly”.

In one development of the invention, the information comprises: a timestamp and/or an identifier, in particular a type identifier, identifying a type of the characteristic variable or the variable based on it. This renders it possible for a cause of the change to be identified or found, in particular at a subsequent time point.

In one development of the invention, the characteristic variable has a rotation speed, a temperature, a pressure, a voltage, a current, a duration and/or a time point. In particular, the characteristic variable is such a type of characteristic variable. Additionally or alternatively, the variable based on the characteristic variable is based on an intermediate variable based on the characteristic variable. The intermediate variable has at least one starting stroke, at least one successful start, a mixture setting, a number of mixture adjustments, a number of interventions by a motor management system of the motor drive system, an ignition adjustment, at least one stopping operation, at least one acceleration, at least one deceleration, an environmental and/or operating condition, a tool identification process, an application identification process and/or an interaction with an environment. In particular, the intermediate variable is such a type of intermediate variable. Further additionally or alternatively, the variable based on the characteristic variable, in particular the rotation speed, has starting strokes for each successful start and/or a ratio of an acceleration, in particular when a user-actuable motor operator control element for operating the motor drive system is actuated, and a deceleration, in particular when the motor operator control element is not actuated successively, in relation to one another. In particular, the variable based on another variable is such a type of variable. This renders it possible for, for example, poor starting and/or running behaviour, an excessive rotation speed owing to glow ignition, operation of the motor drive system under extreme environmental conditions and/or a deflection of a mixture controller, in particular of the motor drive system, to be identified. In particular, the starting strokes for each successful start can render possible or provide or allow identification or a statement or a conclusion about the readiness of the motor drive system to start to be made. Additionally or alternatively, the ratio of the acceleration and the deceleration in relation to one another can render possible or be an identification or an indication of a power loss in the motor drive system, for example caused by a broken bearing and/or a clamped tool. Further additionally or alternatively, the characteristic variable can have, in particular be, a energization period of a fuel valve and/or a time of the end of energization and/or an ignition output. Further additionally or alternatively, the characteristic variable or the intermediate variable can have, in particular be, an ambient temperature, a motor temperature, an ambient pressure, an operating pressure and/or a moisture level, in particular based on or derived from the voltage. Further additionally or alternatively, the term “comedown” can be used synonymously with the term “deceleration”. Further additionally or alternatively, the motor operator control element can be a user-movable, and in particular self-resetting, motor operator control element. Further additionally or alternatively, the non-actuation of the motor operator control element can have, in particular be, release of the motor operator control element. Further additionally or alternatively, the intermediate variable can have, in particular be, a type of tool identification and/or a tool blocking identification. That is to say, the rotation speed is continuous within an, in particular specified, time window for a duration greater than an, in particular specified, duration limit value.

In one development of the invention, the method comprises: detection and/or storage of the characteristic variable and/or a, in particular the, variable based on it and/or storage of the information depending on an operating state of the motor drive system. In particular, the operating state can render possible, in particular pronounced, occurrence and/or, in particular therefore, an, in particular simple, identification of, in particular an effect of, the change. In particular, the operating state can have, in particular be, a start and/or a full load of the motor drive system.

In one development of the invention, the motor drive system has an internal combustion drive engine system and/or electric motor drive system. In particular, the motor drive system is the internal combustion drive engine system and/or electric motor drive system. In particular, the gardening, forestry, construction or soil-working device can be a rechargeable battery-powered device.

In one development of the invention, the gardening, forestry, construction or soil-working device is manually operated and/or controlled, in particular hand-held. Additionally or alternatively, the gardening, forestry, construction or soil-working device is a lawnmower, a scarifier, a grass trimmer, a circular trimmer, a brushcutter, a hedge clipper, a hedge cutter, a woodcutter, a saw, an angle grinder, a pole-mounted pruner, a lopper, an olive harvester, a leaf blower, a blower device, a suction device, a leaf vacuum, a shredder, a sweeping device, a sweeping roller, a sweeping brush, a pressure washer, a cleaning device, a soil-drilling device, a stonecutter, a rotovator or a sprayer. In the case of such a type of gardening, forestry, construction or soil-working device, capabilities can be particularly limited.

In one development of the invention, the method comprises the step of: transmission, in particular wireless and/or automatic transmission, of the stored information or information based on it from the gardening, forestry, construction or soil-working device, in particular to a diagnosis device. This renders it possible for a cause of the change to be identified or found or for a diagnosis, in particular of the gardening, forestry, construction or soil-working device, to be made. Additionally or alternatively, this renders it possible for a complaint, in particular by a user of the gardening, forestry, construction or soil-working device, to be understood, in particular wherein the user cannot adequately cite the problem with the gardening, forestry, construction or soil-working device. Further additionally or alternatively, this renders it possible for, in particular targeted, recommended handling for the gardening, forestry, construction or soil-working device to be able to be provided. Further additionally or alternatively, this renders it possible for on-board diagnosis, in particular of the gardening, forestry, construction or soil-working device, to be avoided. Therefore, this renders it possible for capabilities of the gardening, forestry, construction or soil-working device to be able to be limited. In particular, the diagnosis device can be updateable, in particular relatively easily in comparison with the gardening, forestry, construction or soil-working device. Therefore, this can render possible up-to-date and/or flexible interpretation of the information. In particular, the transmission can be wired. Additionally or alternatively, the term “wire-free” can be used synonymously with the term “wireless”. Further additionally or alternatively, the transmission can be a transmission of a, in particular the, content of the information. Further additionally or alternatively, the transmission can be performed by means of a gateway, in particular wirelessly. Further additionally or alternatively, the diagnosis device can be different, in particular distinct or separate, from the gardening, forestry, construction or soil-working device. Further additionally or alternatively, the diagnosis device can be in the form of a cloud. Further additionally or alternatively, the diagnosis device can be mobile and/or electrical and/or have an output device, in particular a display, for outputting the transmitted information or information based on it, in particular a smartphone.

The mobile gardening, forestry, construction or soil-working device according to the invention is designed for, in particular for the and/or automatic, determination of, in particular the, information about a, in particular the, change of the gardening, forestry, construction or soil-working device. The gardening, forestry, construction or soil-working device has an, in particular the, motor drive system. The gardening, forestry, construction or soil-working device is designed: for, in particular for the, detection repeated in respect of time, and in particular automatic detection, of a, in particular the, characteristic variable of the motor drive system; for, in particular for the and/or automatic, comparison of at least one, in particular the, first value of the detected characteristic variable or a, in particular the, variable based on it from an, in particular the, first time period and at least one, in particular the, second value of the detected characteristic variable or the variable based on it from a, in particular the, second time period with one another; and for, in particular for the and/or automatic, storage of the information about the change of the gardening, forestry, construction or soil-working device depending on a, in particular the, result of the comparison.

The gardening, forestry, construction or soil-working device can render possible the same advantage/advantages as the method cited above.

In particular, the gardening, forestry, construction or soil-working device can be designed for, in particular automatic, execution of a, in particular the, method as cited above.

The system according to the invention has a mobile, in particular the mobile, gardening, forestry, construction or soil-working device as cited above and an, in particular the, diagnosis device. The gardening, forestry, construction or soil-working device is designed for, in particular for the, transmission, in particular wireless and/or automatic transmission, of the stored information or, in particular the, information based on it from the gardening, forestry, construction or soil-working device to the diagnosis device.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a system according to an embodiment of the invention having a mobile gardening, forestry, construction or soil-working device and a diagnosis device and an exemplary method for determination of information about a change of the mobile gardening, forestry, construction or soil-working device.

FIG. 2 schematically shows the details of the gardening, forestry, construction or soil-working device and the method of FIG. 1.

FIG. 3 schematically shows further details of the system, the gardening, forestry, construction or soil-working device and the method of FIG. 1.

FIG. 4 schematically shows a variation over time of a variable in the form of starting strokes for each successful start.

FIG. 5 schematically shows a variation over time of a variable in the form of a ratio of an acceleration and a deceleration in relation to one another.

### DETAILED DESCRIPTION OF THE DRAWINGS

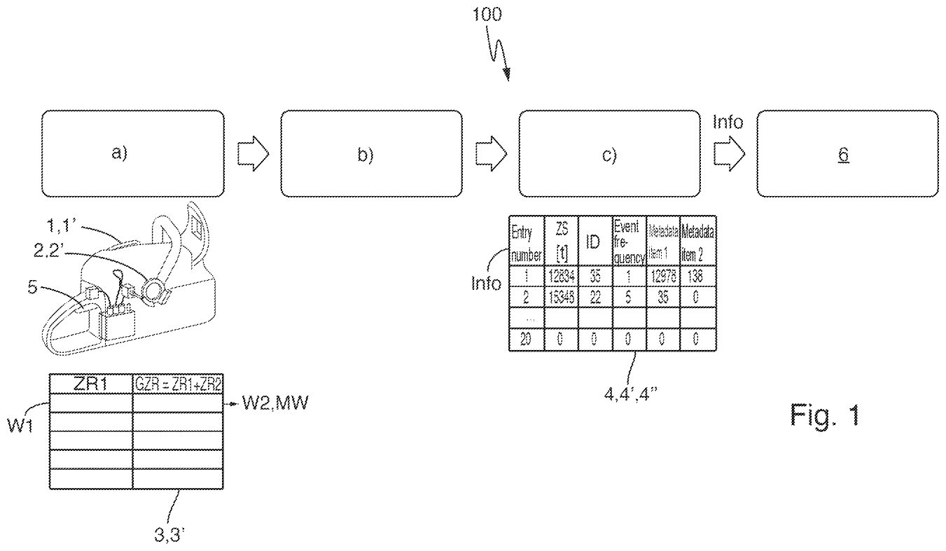

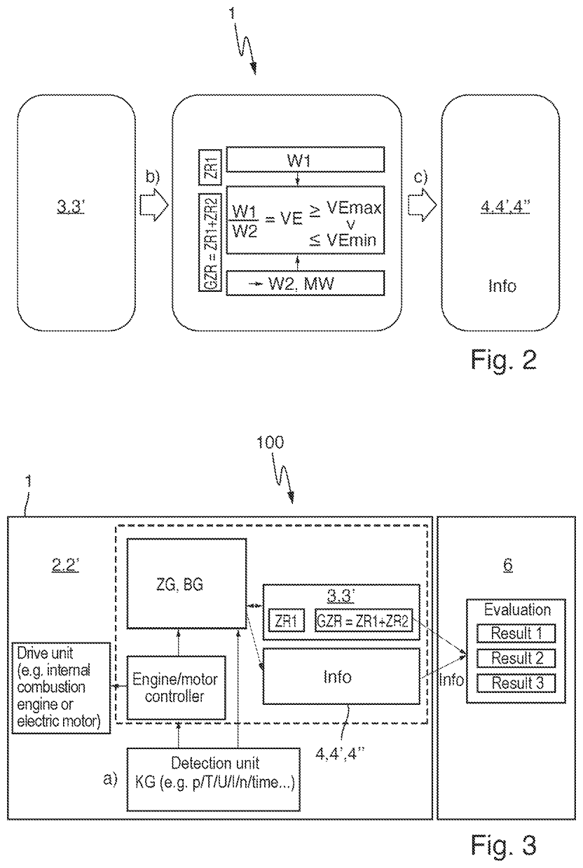

FIGS. 1 and 3 show a system 100. The system 100 has a mobile gardening, forestry, construction or soil-working device 1 for determination of information Info about a change VA in the gardening, forestry, construction or soil-working device 1, as shown in FIGS. 1 to 5.

The gardening, forestry, construction or soil-working device 1 has a motor drive system 2.

The gardening, forestry, construction or soil-working device 1 is designed for repeated detection of, in particular detects, a characteristic variable KG of the motor drive system 2; for comparison of, in particular compares, at least one first value W1 of the detected characteristic variable or a variable BG1 based on it from a first time period ZR1 and at least one second value W2 of the detected characteristic variable or the variable BG2 based on it from a second time period with one another; for storage of, in particular stores, the information Info about the change VA of the gardening, forestry, construction or soil-working device 1 depending on a result of the comparison.

FIGS. 1 to 3 show a method for the determination of the information about the change VA of the mobile gardening, forestry, construction or soil-working device 1. The method comprises the steps of: a) repeated detection of a characteristic variable KG of the motor drive system 2 in respect of time, in particular by means of the gardening, forestry, construction or soil-working device 1, b) comparison of at least the first value W1 of the detected characteristic variable or the variable BG1 based on it from the first time period ZR1 and at least the second value W2 of the detected characteristic variable or the variable BG2 based on it from a second time period ZR2 with one another, in particular by means of the gardening, forestry, construction or soil-working device 1, and c) storage of the information Info about the change VA of the gardening, forestry, construction or soil-working device 1 depending on a result of the comparison, in particular by means of the gardening, forestry, construction or soil-working device 1.

Specifically, the method comprises the step of: transmission of the stored information Info or information based on it from the gardening, forestry, construction or soil-working device 1, in particular to a diagnosis device 6.

The system 100 has the diagnosis device 6. The gardening, forestry, construction or soil-working device 1 is designed: for the transmission of, in particular transmits, the stored information Info or information based on it from the gardening, forestry, construction or soil-working device 1 to the diagnosis device 6.

Furthermore, the gardening, forestry, construction or soil-working device is manually operated and/or controlled, in particular hand-held.

In the exemplary embodiment shown, the gardening, forestry, construction or soil-working device 1 is a saw 1′. In alternative exemplary embodiments, the gardening, forestry, construction or soil-working device can be a lawnmower, a scarifier, a grass trimmer, a circular trimmer, a brushcutter, a hedge clipper, a hedge cutter, a woodcutter, an angle grinder, a pole-mounted pruner, a lopper, an olive harvester, a leaf blower, a blower device, a suction device, a leaf vacuum, a shredder, a sweeping device, a sweeping roller, a sweeping brush, a pressure washer, a cleaning device, a soil-drilling device, a stonecutter, a rotovator or a sprayer.

In addition, the motor drive system 2 has an internal combustion drive engine system and/or electric motor drive system 2′. In particular, the motor drive system 2 is the internal combustion drive engine system and/or electric motor drive system 2′.

The gardening, forestry, construction or soil-working device 1 further has a variable memory device 3 and/or an event memory device 4. Step a) comprises: storage of the detected characteristic variable or a variable ZG1, ZG2 based on it in the variable memory device 3. Step b) comprises: comparison of at least the first value W1 of the stored characteristic variable or the stored variable or a, in particular the, variable BG1 based on it and at least the second value W2 of the stored characteristic variable or the stored variable or the variable BG2 based on it with one another. Additionally or alternatively, step c) comprises: storage of the information Info in the event memory device 4.

Specifically, the variable memory device 3 is a non-volatile variable memory device 3′. Additionally or alternatively, the event memory device 4 is a non-volatile event memory device 4′ and/or has a ring memory 4″, in particular is the ring memory 4″.

In addition, the second time period ZR2 is longer than the first time period ZR1, in particular the second time period ZR2 is a total run time period GZR apart from the, in particular current, first time period ZR1. Additionally or alternatively, the second time period ZR2 at least partially, in particular completely, precedes the, in particular current, first time period ZR1.

Furthermore, the second time period ZR2 has first time periods ZR1′, in particular preceding the, in particular current, first time period ZR1. In particular, the second time period ZR2 is the first time periods ZR1′. Additionally or alternatively, the second value W2 is a mean value MW and/or an accumulated value of values W1′ of the detected characteristic variable or the variable BG1′ based on it from first time periods ZR1′, in particular preceding the, in particular current, first time period ZR1.

In addition, step b) comprises: forming a ratio VE of at least the first value W1 and at least the second value W2 in relation to one another, in particular by means of the gardening, forestry, construction or soil-working device 1. Step c) comprises: storage depending on whether the ratio VE is equal to or greater than a ratio maximum limit value VEmax or equal to or less than a ratio minimum limit value VEmin, in particular wherein the ratio minimum limit value VEmin is less than the ratio maximum limit value VEmax.

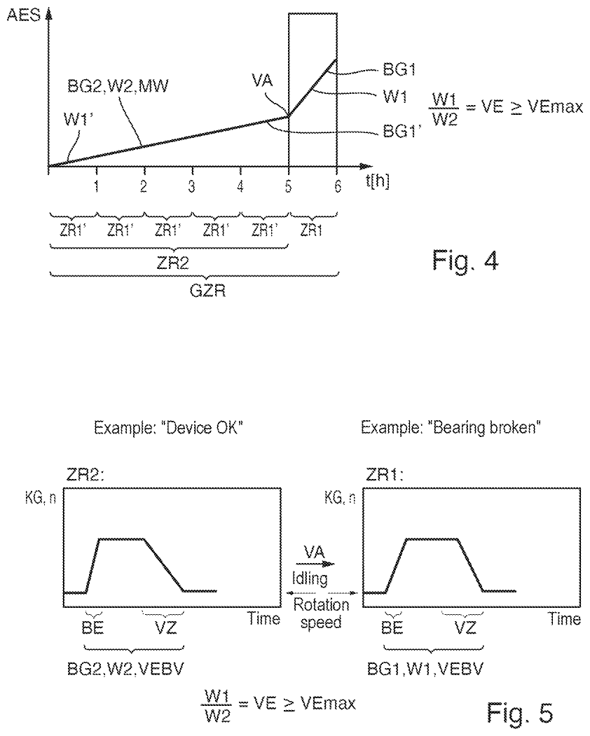

In FIGS. 4 and 5, the ratio VE is equal to or greater than the ratio maximum limit value VEmax. Therefore, it is stored.

Step b) further comprises: repeated comparison of at least one, in particular current, first value W1 of the detected characteristic variable or the variable BG1 based on it from an, in particular current, first time period ZR1 and at least one, in particular current, second value W2 of the detected characteristic variable or the variable BG2 based on it from an, in particular current, second time period ZR2 with one another in respect of time. Step c) comprises: storage of the information Info about the change VA of the gardening, forestry, construction or soil-working device 1 depending on a result of the repeated comparison in respect of time and whether information about a change of the gardening, forestry, construction or soil-working device had not been stored, in particular directly, beforehand depending on at least the result at least of the, in particular directly, preceding comparison.

That is to say, if after storage of the information for at least one execution of the method, in particular of step b) and/or step c), or one working cycle, a condition for storage is no longer met, renewed storage of the information is permitted again in subsequent or following executions of the method, in particular of step b) and/or step c), or working cycles.

In addition, the information Info comprises: a timestamp ZS and/or an identifier ID identifying a type of the characteristic variable or the variable BG based on it.

Furthermore, the characteristic variable KG has a rotation speed n, a temperature T, a pressure p, a voltage U, a current I, a duration and/or a time point. In particular, the characteristic variable is such a type of characteristic variable. Additionally or alternatively, the variable BG based on the characteristic variable KG is based on an intermediate variable ZG based on the characteristic variable KG. The intermediate variable ZG has at least one starting stroke A, at least one successful start ES, a mixture setting, a number of mixture adjustments, a number of interventions by a motor management system of the motor drive system, an ignition adjustment, at least one stopping operation, at least one acceleration BE, at least one deceleration VZ, an environmental and/or operating condition, a tool identification process, an application identification process and/or an interaction with an environment. In particular, the intermediate variable is such a type of intermediate variable. Further additionally or alternatively, the variable BG based on the characteristic variable KG, in particular the rotation speed n, has starting strokes for each successful start AES, as shown in FIG. 4, and/or a ratio VEBV of an acceleration BE, in particular when a user-actuable motor operator control element 5 for operating the motor drive system 2 is actuated, and a deceleration VZ, in particular when the motor operator control element 5 is not actuated successively, in relation to one another, as shown in FIG. 5. In particular, the variable based on it is such a type of variable.

In a properly functioning gardening, forestry, construction or soil-working device with low pressure injection, the starting strokes for each successful start AES move between 1.3 and 1.5. If the value is clearly above this, e.g. greater than or equal to 2, this indicates a change and therefore a problem. In a properly functioning gardening, forestry, construction or soil-working device without low-pressure injection, the values may also be considerably greater, in particular greater than 2, since in this case the advantage of low-pressure injection (pilot control of ignition/injection on the basis of temperature and ambient pressure) is lost.

In the event of a change of a gardening, forestry, construction or soil-working device from a properly functioning state, as shown on the left-hand side in FIG. 5, to a broken state, in particular on account of a broken bearing, as shown on the right-hand side in FIG. 5, the motor drive system, in particular the power unit, has to provide more power for the acceleration due to the increased friction. The duration of the acceleration is increased or extended. In association, the deceleration becomes steeper. Therefore, the ratio of the acceleration and the deceleration in relation to one another changes.

In addition, the method comprises: detection and/or storage of the characteristic variable KG and/or a, in particular the, variable ZG, BG based on it and/or storage of the information Info depending on an operating state of the motor drive system 2.

As is made clear by the exemplary embodiments shown and explained above, the invention provides an advantageous method for determination of information about a change of a mobile gardening, forestry, construction or soil-working device, an advantageous mobile gardening, forestry, construction or soil-working device for determination of information about a change of the gardening, forestry, construction or soil-working device, and an advantageous system having such a gardening, forestry, construction or soil-working device, wherein the method, the gardening, forestry, construction or soil-working device and the system each have improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for determining information about a change of a mobile gardening, forestry, construction or soil-working device, wherein the gardening, forestry, construction or soil-working device has a motor drive system, the method comprising the steps of:
a) repeatedly detecting a characteristic variable of the motor drive system in respect of time;
b) comparing at least one first value of the detected characteristic variable or a variable based on it from a first time period and at least one second value of the detected characteristic variable or the variable based on it from a second time period with one another; and
c) storing the information about the change of the gardening, forestry, construction or soil-working device depending on a result of the comparison.

2. The method according to claim 1,
wherein the gardening, forestry, construction or soil-working device has a variable memory device and/or an event memory device, and
wherein step a) comprises: storing the detected characteristic variable or a variable based on it in the variable memory device, and wherein step b) comprises: comparing at least the first value of the stored characteristic variable or the stored variable or a variable based on it and at least the second value of the stored characteristic variable or the stored variable or the variable based on it with one another, and/or
wherein step c) comprises: storing the information in the event memory device.

3. The method according to claim 2,
wherein the variable memory device is a non-volatile variable memory device, and/or
wherein the event memory device is a non-volatile event memory device and/or is a ring memory.

4. The method according to claim 1,
wherein the second time period is longer than the first time period, and/or
wherein the second time period at least partially precedes the first time period.

5. The method according to claim 4, wherein
the second time period is a total run time period apart from the first time period, and/or
the second time period completely precedes the first time period.

6. The method according to claim 1,
wherein the second time period has first time periods preceding a current, first time period, and/or
wherein the second value is a mean value and/or an accumulated value of values of the detected characteristic variable or the variable based on it from the first time periods preceding the current, first time period.

7. The method according to claim 1,
wherein step b) comprises: forming a ratio of at least the first value and at least the second value in relation to one another, and
wherein step c) comprises: storing the information depending on whether the ratio is equal to or greater than a ratio maximum limit value or equal to or less than a ratio minimum limit value, wherein the ratio minimum limit value is less than the ratio maximum limit value.

8. The method according to claim 1,
wherein step b) comprises: repeatedly comparing at least one, current, first value of the detected characteristic variable or the variable based on it from a current first time period and at least one, current, second value of the detected characteristic variable or the variable based on it from a current second time period with one another in respect of time, and
wherein step c) comprises: storing the information about the change of the gardening, forestry, construction or soil-working device depending on a result of the repeated comparison in respect of time and whether information about a change of the gardening, forestry, construction or soil-working device had not been stored beforehand depending on the result of the preceding comparison.

9. The method according to claim 1,
wherein the information comprises: a timestamp and/or an identifier identifying a type of the characteristic variable or the variable based on it.

10. The method according to claim 1,
wherein the characteristic variable is a rotation speed, a temperature, a pressure, a voltage, a current, a duration, and/or a time point, and/or
wherein the variable based on the characteristic variable is based on an intermediate variable based on the characteristic variable, wherein the intermediate variable is at least one starting stroke, at least one successful start, a mixture setting, a number of mixture adjustments, a number of interventions by a motor management system of the motor drive system, an ignition adjustment, at least one stopping operation, at least one acceleration, at least one deceleration, an environmental and/or operating condition, a tool identification process, an application identification process, and/or an interaction with an environment, and/or
wherein the variable based on the rotation speed is starting strokes for each successful start and/or a ratio of an acceleration when a user-actuable motor operator control element for operating the motor drive system is actuated, and a deceleration when the motor operator control element is not actuated successively, in relation to one another.

11. The method according to claim 1, further comprising:
detecting and/or storing the characteristic variable and/or a variable based on it, and/or storing the information depending on an operating state of the motor drive system.

12. The method according to claim 1,
wherein the motor drive system is an internal combustion drive engine system and/or an electric motor drive system.

13. The method according to claim 1,
wherein the gardening, forestry, construction or soil-working device is manually operated and/or controlled, and/or
wherein the gardening, forestry, construction or soil-working device is a lawnmower, a scarifier, a grass trimmer, a circular trimmer, a brushcutter, a hedge clipper, a hedge cutter, a woodcutter, a saw, an angle grinder, a pole-mounted pruner, a lopper, an olive harvester, a leaf blower, a blower device, a suction device, a leaf vacuum, a shredder, a sweeping device, a sweeping roller, a sweeping brush, a pressure washer, a cleaning device, a soil-drilling device, a stonecutter, a rotovator or a sprayer.

14. The method according to claim 1, further comprising:
wirelessly transmitting the stored information or information based on it from the gardening, forestry, construction or soil-working device to a diagnostic device.

15. A mobile gardening, forestry, construction or soil-working device for determining information about a change of the gardening, forestry, construction or soil-working device, comprising:
a motor drive system of the gardening, forestry, construction or soil-working device,
wherein the gardening, forestry, construction or soil-working device is configured to:
repeatedly detect a characteristic variable of the motor drive system in respect of time,
compare at least one first value of the detected characteristic variable or a variable based on it from a first time period and at least one second value of the detected characteristic variable or the variable based on it from a second time period with one another, and
store the information about the change of the gardening, forestry, construction or soil-working device depending on a result of the comparison.

16. A system, comprising:
a mobile gardening, forestry, construction or soil-working device according to claim 15; and
a diagnostic device,
wherein the gardening, forestry, construction or soil-working device is designed for transmitting the stored information or information based on it from the gardening, forestry, construction or soil-working device to the diagnostic device.

17. The system according to claim 16, wherein the transmitting is a wireless transmission.
